(19) United States
(12) Patent Application Publication
(10) Pub. No.: US 2016/0125624 A1
(43) Pub. Date: May 5, 2016

(54) AN APPARATUS AND ASSOCIATED METHODS

(71) Applicant: NOKIA TECHNOLOGIES OY, Espoo (FI)

(72) Inventors: Yingfei LIU, Beijing (CN); Kongqiao WANG, Beijing (CN)

(73) Assignee: Nokia Technologies Oy, Espoo (FI)

(21) Appl. No.: 14/894,486

(22) PCT Filed: May 29, 2013
(86) PCT No.: PCT/CN2013/076422

§ 371 Date: Nov. 27, 2015

(51) Int. Cl. G06T 11/00; A45D 44/00; G06K 9/00; G09G 5/06; H04N 5/225

(52) U.S. Cl. CPC G06T 11/001; G09G 5/06; H04N 5/225; G06K 9/00228; G06K 9/00288; G06K 9/00369; A45D 44/005

(57) ABSTRACT

An apparatus, the apparatus comprising at least one processor, and at least one memory including computer program code, the at least one memory and the computer program code configured, with the at least one processor, to cause the apparatus to perform at least the following: based on an indication of captured colour, the colour captured from a real-world object, provide for application of the captured colour to an identified body feature in a computer generated image of a body.

### TECHNICAL FIELD

The present disclosure relates to image processing using electronic devices, associated methods, computer programs and apparatus. Certain disclosed embodiments may relate to portable electronic devices, for example so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

A user may wish to edit an image on a computer by changing colours, adding or removing features from the image, and/or applying an artistic effect to the image. An electronic device may allow a user to interact with an image to edit it in different ways.

The listing or discussion of a prior-published document or any background in this specification should not necessarily be taken as an acknowledgement that the document or background is part of the state of the art or is common general knowledge. One or more embodiments of the present disclosure may or may not address one or more of the background issues.

### SUMMARY

In a first example embodiment there is provided an apparatus comprising at least one processor and at least one memory including computer program code, the at least one memory and the computer program code configured to, with the at least one processor, cause the apparatus to perform at least the following: based on an indication of captured colour, the colour captured from a real-world object, provide for application of the captured colour to an identified body feature in a computer generated image of a body.

A user may have a computer generated image of his/her face (as a body feature) available on an electronic device. A computer generated image is an image which is stored on a computer, and available for output from a computer. The computer generated image may be captured using a digital camera or a digital video camera, and output as a displayed image on a computer display screen. The image is computer generated as it is stored as computer accessible data, for example, as an image file on a computer readable medium or as a transient live signal from a digital video camera. The computer generated image may be generated from the data for display on a display screen.

Facial features may be identified on the computer generated image. For example, the image may comprise user designated/automatically designated regions designated/identified as hair, eyes, nose and mouth regions. A colour may be captured from a real world object, such as a make up item. Other real-world objects include, for example, a person, a photograph of a person (which may be displayed on a display screen or in a photograph or poster, for example), and packaging for a cosmetic product.

The captured colour may be applied to the identified region in the computer generated image. Thus, for example, a user may capture the colour of a foundation powder, and the captured colour may be applied in the computer generated image to the regions designated as skin (such as cheeks, chin, nose and forehead), but not to regions which are not designated as skin (such as hair, eyes, eyebrows and lips). Thus a user may see what a particular colour of cosmetic looks like on his/her face/body without physically trying the cosmetic by looking at the computer generated image having the captured colour presented on the image in an appropriate region of the image.

The identified body feature may be a facial feature in some examples or a non-facial feature in some examples.

As an example, non-facial body features may be identified and a captured colour applied in a computer generated image of a body. For example, a user may capture the colour of a nail varnish by holding the bottle of nail varnish next to a fingernail and taking a photograph of the bottle and the user's hand. The apparatus may provide for the application of the captured nail varnish colour to the user's fingernails in the computer generated image of the user's hand captured by the camera (or in another (e.g., pre stored) image of the user's hand). Thus the user may see how the nail varnish colour looks like on her hand without physically painting a nail. A similar example would be to apply a nail colour to toenails in a computer generated image of a user's foot/feet.

As another example applicable to non-facial body features, a user may capture the colour of a tanning product and see how the tan colour looks in a computer generated image of the user's legs, back, arms, and/or torso, for example.

The apparatus may be configured to identify the body feature for the application of the captured colour based on user indication of one or more of:
the body feature from a display of selectable body features;
the body feature in the real-world; and
the body feature from a display of one or more selectable products respectively associated with a particular body feature.

The display of selectable body features may be one or more of: a list of selectable body features; and a graphical representation of selectable body features. The list may be a text-based list/menu listing different body features such as lips, skin, hair, eyes, legs and arms, for example. The graphical representation may be a menu of icons/symbols each representing a body feature. The graphical representations may be, for example, schematic/cartoon images, or may be realistic images, for example extracted from a photographic image of the user's face and/or body. The graphical representation may be, for example, the computer generated image of the user's face/body, which the user may interact with, for example by touching a region of or associated with the image on a touch sensitive screen or by selecting a feature on the image using a mouse controlled pointer or similar.

The user indication of the body feature in the real-world may be provided to the apparatus by a camera of the apparatus or a camera external to the apparatus. For example, a user may point to a body feature, and the pointer and/or location on the body indicated by the pointer may be captured by a camera and provided to the apparatus. The pointer may be, for example, the user's finger or a cosmetic product, such as a lipstick, concealer wand or mascara brush. The image captured by the camera may be provided to the apparatus for analysis, and/or the results of the analysed captured image may be provided to the apparatus to allow for the indication of the body feature.

The user indication of the body feature in the real-world may be at least one of: a body feature of the same body to which the captured colour is applied; and a body feature of a different body to which the captured colour is applied. For example, a user may point to his/her own real face which is the same as the face in the computer generated image to which the captured colour is applied. As another example, a user may point to an image of his/her own face such as a photograph of the user's face. As another example, a user may point to a feature on another face, such as on a friend's real face, a face in a magazine or billboard advertisement, or a face on packaging of a cosmetic product such as a hair dye or a foundation cream.

The display of one or more selectable products may comprise one or more of a list or graphical representation of: a wig product, a hair colour product, a lipstick product (such as a lipstick, lip stain or lip gloss), an eye area colour product, an eyelash colour product (such as mascara or eyelash dye), an eyebrow colour product, a concealer product, a foundation product (such as a powder, liquid, cream or mousse), a blusher product (such as a cheek blusher, bronzer or shimmer powder), a tanning product and a nail colour (such as a nail varnish/polish or false nails).

The selectable product may be associated with the real-world object from which the colour has been captured. For example, a user may capture an image of a lipstick. The captured colour may be the colour of the lipstick, and the selectable product may be the lipstick product. The facial feature may then be logically indicated as lips since a lipstick has been identified in the captured image and lipstick is usually applied to the lips and not to other facial features.

The identified body feature may be a facial feature, and the apparatus may be configured to identify the facial feature for the application of the captured colour based on computer-based auto-recognition of one or more of:
the facial feature in the computer generated image of the face;
the facial feature in the real-world; and
the facial feature from a real-world product associated with a particular facial feature.

The identified body feature may be a facial feature, and the apparatus may be configured to perform facial recognition to identify the facial feature to which the captured colour is applied. Another apparatus may be configured to perform facial recognition and may provide the results to the apparatus to identify the facial feature to which the captured colour is applied. Facial recognition may make use of algorithms such as an active appearance model (AAM) or an active shape model (ASM). Such algorithms may be considered to perform facial landmark localisation for identifying/detecting where particular facial features are located in a computer generated image of a face.

Facial recognition may be performed on the computer generated image, on a real world face such as a live feed of the user's face and/or a live image of a friend's face or from a real-world product associated with a particular facial feature such as a face in a picture (e.g., in a magazine or product packaging).

The apparatus may comprise a camera, and the apparatus may be configured to use the camera to capture one or more of:
the colour from the real-world object; and
an image of a body for generation of the computer generated image of the body to which the captured colour is applied.

The apparatus may be configured to provide for the application of captured colour, comprising a single captured colour, from the real-world object, to the identified body feature. For example, the colour of an eyeshadow may be captured and applied to the eyelid region in the computer generated image of a face. As another example, the colour of a nail polish may be captured and the colour applied to the toenail regions of a computer generated image of a foot.

The apparatus may be configured to provide for the application of captured colour, comprising a plurality of captured colours, from the real-world object, to the identified body feature. For example, an image of a foundation advertisement may be captured, including a model's eyes, hair, and lips. If the user is interested in the colour of the foundation and not the colour of the model's hair and lips, the colour of the foundation may be applied to the computer generated image and not the colours of the hair and lips. The colour can be the same shade of colour or different shades of the particular colour. The colour could be a single colour or multiple different colours, such as different hair colours which may be applied using a multi-tonal/highlighting hair colouring kit, or different eye shadow shades/colours in different regions of the same eye (or different eyes).

The apparatus may be configured to provide for the application of one or more of the captured colours from a plurality of captured colours, from the real-world object, to the identified body feature based on user selection of the one or more captured colours. For example, a user may be able to select to apply the captured lip and skin colours to an image, but not captured hair and eye make up colours.

The coloured image of the real-world object may comprise substantially the same captured colour throughout the coloured image.

The identified body feature may be: hair, lips, skin, cheeks, under-eye area, eyelids, eyelashes, lash-line, brow bones, eyebrows, an arm, a leg, a hand, a foot, a fingernail, a toenail, a chest, a torso, or a back.

The real-world object may be: a cosmetic product (e.g., lipstick, powder, nail varnish), a package for a cosmetic product (e.g., hair dye box, foundation compact, fake tan bottle), a colour chart (e.g., a tanning or foundation shade chart at a make-up counter), an image of a body, an image of a face (e.g., on a magazine page or billboard), a real-world body or a real-world face (e.g., a friend's face).

The apparatus may be configured to display the computer generated image of the body on a display of at least one of the apparatus and a portable electronic device (which may be separate/remote to the apparatus).

The apparatus may be configured to apply the captured colour to the identified body feature in the computer generated image of the body.

The apparatus may be one or more of: a portable electronic device, a mobile phone, a smartphone, a tablet computer, a surface computer, a laptop computer, a personal digital assistant, a graphics tablet, a pen-based computer, a digital camera, a watch, a non-portable electronic device, a desktop computer, a monitor/display, a household appliance, a server, or a module for one or more of the same.

According to a further example embodiment, there is provided a method, the method comprising: based on an indication of captured colour, the colour captured from a real-world object, providing for application of the captured colour to an identified body feature in a computer generated image of a body.

According to a further example embodiment, there is provided a computer readable medium comprising computer program code stored thereon, the computer readable medium and computer program code being configured to, when run on at least one processor perform at least the following: based on an indication of captured colour, the colour captured from a real-world object, provide for application of the captured colour to an identified body feature in a computer generated image of a body.

According to a further example embodiment there is provided an apparatus comprising means for providing for application of a captured colour to an identified body feature in a computer generated image of a body based on an indication of the captured colour, the colour captured from a real-world object.

The present disclosure includes one or more corresponding aspects, embodiments or features in isolation or in various combinations whether or not specifically stated (including claimed) in that combination or in isolation. Corresponding means and corresponding function units (e.g., colour capturer, captured colour indicator, captured colour applicator, body/facial feature identifier, body/facial image generator) for performing one or more of the discussed functions are also within the present disclosure.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product. Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus embodiment comprising a number of electronic components, including memory and a processor, according to one embodiment of the present disclosure;

FIG. 2 illustrates an example apparatus embodiment comprising a number of electronic components, including memory, a processor and a communication unit, according to another embodiment of the present disclosure;

FIG. 3 illustrates an example apparatus embodiment comprising a number of electronic components, including memory and a processor, according to another embodiment of the present disclosure;

FIGS. 4a-4d illustrate applying a colour captured from the real world to an identified facial feature in a computer generated image of a face according to embodiments of the present disclosure;

FIGS. 5a-5b illustrate lists of selectable facial features according to embodiments of the present disclosure;

FIGS. 6a-6b illustrate lists of selectable products respectively associated with particular facial features according to embodiments of the present disclosure;

FIGS. 7a-7g illustrate capturing a colour from the real world, identifying a user indicated product type form the real world, and identifying a facial feature from a user indication according to embodiments of the present disclosure;

FIGS. 8a-8b illustrate computer-based facial recognition according to embodiments of the present disclosure;

FIG. 9 illustrates capturing a colour from the real world and providing for identification of a non-facial feature to which to apply the captured colour;

FIGS. 10a-10b each illustrate an apparatus in communication with a remote computing element;

FIG. 11 illustrates a flowchart according to an example method of the present disclosure; and

FIG. 12 illustrates schematically a computer readable medium providing a program.

### DESCRIPTION OF EXAMPLE ASPECTS/EMBODIMENTS

A person may wish to see how a particular colorful cosmetic looks without actually trying the cosmetic. For example, a person may wish to buy a lipstick, but may not be able to test the lipstick on her lips (e.g., for hygiene reasons, or because the person is already wearing a lip cosmetic). As another example, a person may wish to buy a hair dye, but cannot try out the hair dye to see if the colour is acceptable before buying the hair dye. As another example, a person may wish to buy a nail varnish, but cannot try out the nail varnish to see if the colour is acceptable before buying the product.

Thus if a person is shopping in a department store, for example, that person may not be able to easily see what cosmetics would look like if he/she personally used them.

An electronic device may allow a user to edit a computer generated image. For example, a user may be able to edit a computer generated image of his/her face/body by changing the colour of certain facial/body features. A user may wish to edit a computer generated image of his/her face/body to make a “virtual test” of coloured cosmetics/products. Such photo editing may require the user to have knowledge of how image/photograph editing software can be used, and may require the user to be skilled in using different features of the software (such as colour selection, feature selection and colour/effect application) to achieve a realistic effect.

Even if the user is skilled in using the editing software, the user may not know which colour matches the particular colour of the product of interest in order to select that colour and edit the image of his/her face/body. A user may be interested in, for example, a particular shade of pink lipstick from a range of many pink lipsticks available from different manufacturers. It would be very difficult to choose a pink shade identical to that of the lipstick of interest from a standard computerised colour palette.

Further, using such image/photograph editing software may take time, and may require the use of an electronic device which is unsuitable for quick and easy use one the fly, such as a desktop computer with mouse, a laptop computer, or a graphics tablet and stylus.

It may be desirable for a user to be able to virtually and accurately test out coloured products and cosmetics while shopping in the high street to see how they would look before buying. A person may not wish to buy an expensive make-up product before seeing how it looks on them personally, as the product is unlikely to be exchangeable in the store after testing/use. A person may not wish to buy and use a permanent hair dye, nail varnish, or tanning product, in case the colour does not suit them, since the product would be difficult to remove after use.

It may be desirable for a person to be able to, quickly and easily, edit/adapt a computer image of his/her face/body to see what a product would look like if they personally used it. It may also be desirable if the person did not require detailed knowledge or skill/expertise in using a particular image editing application/software.

It may be desirable for a person to be able to see what the particular colour of a real particular product would look like if the person used it. Checking the particular colour accurately may be important when considering how a certain shade looks from a range of similar shades available in a store.

Embodiments discussed herein may be considered to allow a user to, based on an indication of captured colour, the colour captured from a real-world object, provide for application of the captured colour to an identified body feature in a computer generated image of a body.

Advantageously a user may be able to capture a colour from the real world, such as capturing the colour of a lipstick in a store, or a hair dye from a hair dye package. The user is not required to test a particular brand of product, nor if the user required to have access to the actual product, since the colour may be captured from an advertisement or from another person wearing the product. The user may then see how that particular colour looks when applied to an appropriate facial/body feature in an image of his/her face/body. If the user finds the product in a store, the user need not buy the product to test it. If the user finds an advertisement or finds another person wearing the product of interest, the user can test out how that colour looks on them personally before finding a store which sells the product and then buying it.

Facial recognition technology may be applied to a computer generated image of the user to, for example, identify the portion of the image corresponding to the user's lips. The colour of a particular lipstick captured from a real lipstick product, for example in a store or worn by another person, may be applied to the identified lip portion in the image. The user can then look at the image which includes the colour of the lipstick applied on the lips in the image, to see if the shade of lipstick suits the user. The user need not buy the lipstick and use it to see how the colour looks.

The computer generated image need not necessarily be an image of the user. If the user was interested in buying a product as a gift for someone, the user could test how a particular product looked on an image of the other person before deciding whether or not to buy it.

Embodiments depicted in the figures have been provided with reference numerals that correspond to similar features of earlier described embodiments. For example, feature number 100 can also correspond to numbers 200, 300 etc. These numbered features may appear in the figures but may not have been directly referred to within the description of these particular embodiments. These have still been provided in the figures to aid understanding of the further embodiments, particularly in relation to the features of similar earlier described embodiments.

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose CPU of the device and the memory 107 is general purpose memory comprised by the device. The display, in other embodiments, may not be touch sensitive.

The input I allows for receipt of signalling to the apparatus 100 from further components, such as components of a portable electronic device (like a touch-sensitive or hover-sensitive display) or the like. The output O allows for onward provision of signalling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

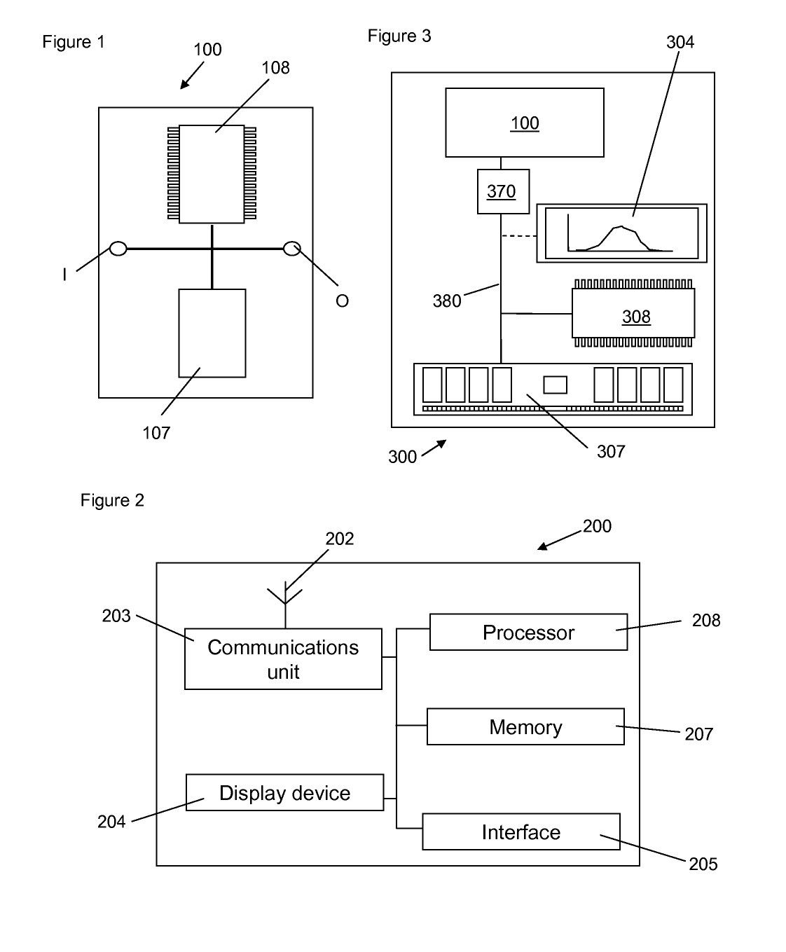

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208.

The example embodiment of FIG. 2 comprises a display device 204 such as, for example, a liquid crystal display (LCD), e-Ink or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The user interface 205 may comprise one or more cameras for image capture. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300 comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

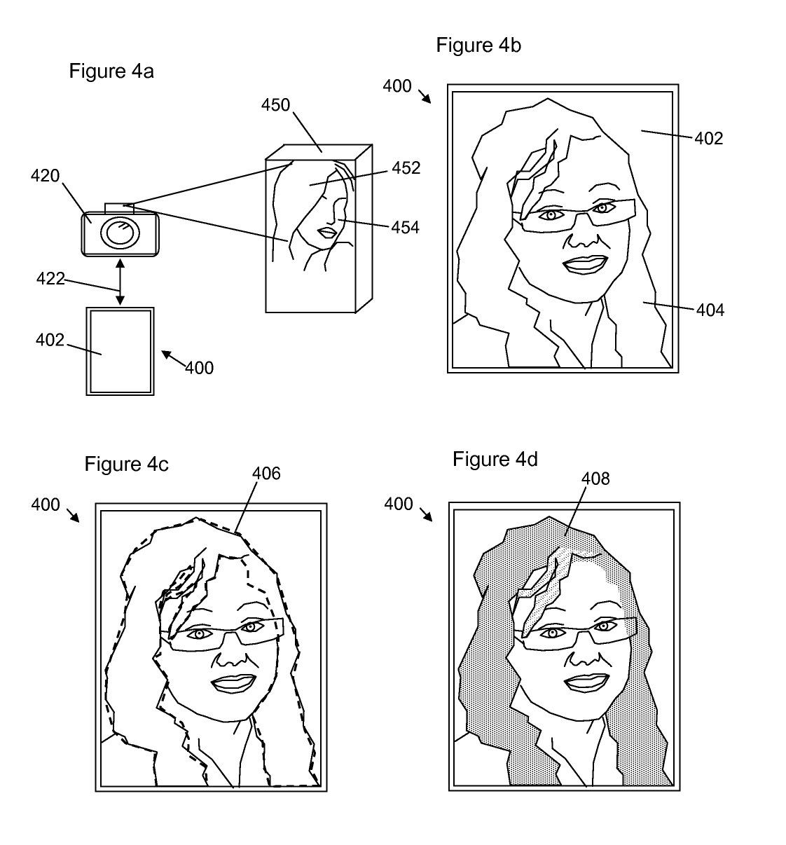

Overall, FIGS. 4a-4d illustrate an example embodiment of an apparatus/device 400 comprising a display screen 402, in which the apparatus/device 400 is configured to provide for the application of a colour 408 captured from a real world product 450 to an identified facial feature 406 in a computer generated image of a face 404.

FIG. 4a shows the apparatus/device 400 in communication 422 with a camera 420. In this example the camera 420 is a separate device to the apparatus/device 400, but in other examples the camera 420 may be integrated within the apparatus/device 400. Also shown in FIG. 4a is a hair dye product box 450. The colour 452 of the hair dye is shown on the front of the box 450. The camera 420 takes a picture of the box 450 and thereby captures the colour 452 of the hair dye. The captured colour 452 is indicated to the apparatus/device 400, by communication 422 between the camera 420 and the apparatus/device 400.

In some examples, the camera 420 may take an image which only, or substantially, captures the portion of the box 450 showing the hair colour 452. In this case the captured colour is the colour 452 which occupies the majority of the recorded image.

In some examples, the camera 420 may take an image which records the portion of the box 450 showing the hair dye colour 452 along with other features and colours such as the face 454 on the box 450. In some such examples facial recognition technology may be used to identify the portions of the image corresponding to different facial features from the facial image 454 on the box 450. The portion of the image corresponding to hair may then be identified and thus the colour 452 of the hair as indicated in the box 450 is captured. In some such examples, the user may be presented with a range of captured colours recorded by the camera 420 for selection of one or more particular captured colours of interest for application to a computer generated image of a face.

In FIG. 4b, the apparatus 400 is displaying a computer generated image of the user's face 404 on the display 402. The user wishes to edit/adapt this image to modify the colour of her hair in the image 404 to that of the hair dye product 450 to see how the hair dye would look on her own hair. In some examples the user may specify that the hair region of the image 404 is the region to which the captured colour should be applied. In some examples the determination that the captured colour should be applied to the hair regions of the image may be automatic.

In FIG. 4c, facial recognition technology has been used to identify different facial features in the image 404. In this example only the region identified as hair 406 is indicated. The apparatus device 400 may perform facial recognition, or another apparatus may perform facial recognition (for example, a remote server) and may provide the results of the facial recognition process to the apparatus/device 400.

In FIG. 4d, the colour 408 captured from the hair dye box 450 has been applied in the region of the image 404 corresponding to the user's hair 406. The user can therefore easily see how the hair dye colour looks on her hair in the image. The user does not need to buy and use the hair dye to see how the colour looks for her personally. The user does not need to manually edit an image by, for example, selecting a specific colour from a palette and then manually shading in the hair region of the image. The user can see her own hairstyle in the image. Thus the user can quickly and accurately see a realistic representation of the particular shade of hair dye 450, for example while out shopping.

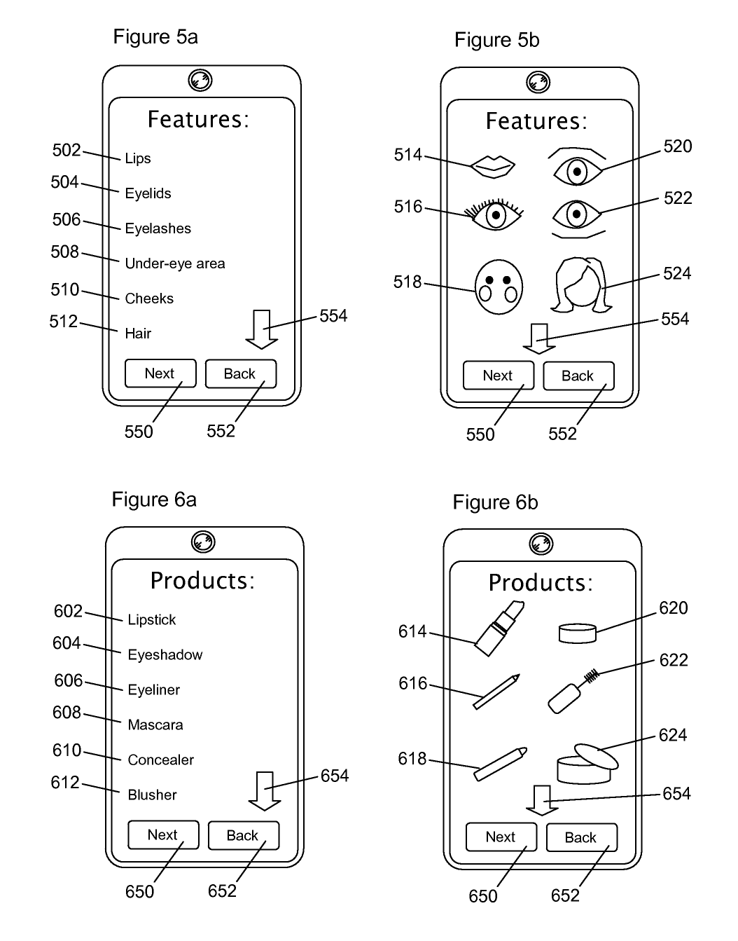

FIGS. 5a-5b, 6a-6b and 7a-7g illustrate how a particular facial feature may be identified by a user making on indication of a particular facial feature. The captured colour can then be applied to that feature in a computer generated image of a face. The facial feature may be user indicated from a display of selectable facial features. The facial feature may be user indicated in the real world. The facial feature may be user indicated from a display of one or more selectable products respectively associated with a particular facial feature. While these examples relate to facial features, of course similar examples apply to body features such as, for example, applying a tanning product colour to an image of a body part such as a person's legs or back, or applying a nail varnish colour to an image of a person's nails.

FIGS. 5a-5b illustrate user-selectable facial features. FIG. 5a shows a text-based list of selectable facial features displayed for user selection on an apparatus/device 500 and FIG. 5b shows a graphical representation of selectable facial features displayed for user selection on an apparatus/device 500. Example option buttons 550, 552 and a scroll arrow 554 are indicated but other options may be provided of course. For example other embodiments may provide both text and graphics.

In FIG. 5a, the example facial features listed are lips 502, eyelids 504, eyelashes 506, under-eye area 508, cheeks 510, and hair 512. In FIG. 5b, the example facial features are displayed as graphical representations of lips 514, eyelids 516, eyelashes 518, under-eye area 520, cheeks 522, and hair 524. Of course other features may be provided for selection including non-facial features such as hands and feet.

In some examples the list/graphical menu may be provided as a menu-submenu system, in which feature categories may be provided in a menu and more specific features for each category may be provided in the submenus. For example, under the menu category “eyes” there may be sub-menu options of “eyelid, browbone, upper lashline, lower lashline, upper eyelashes, lower eyelashes, eyebrow” for selection.

A colour may have been captured from a real-world object. A computer generated image of the user's body/face may be available. The user may select a body/facial feature from a list/menu as shown in FIG. 5a or 5b to indicate what feature in the image should be edited by the application of the captured colour.

It may be that a colour has been captured, but the apparatus/device 500 requires user input to know which body/facial feature to apply the captured colour to. The user can select a body/facial feature from a list as in FIG. 5a or a graphical menu as in FIG. 5b to provide an input to the apparatus/device 500 instructing what feature to apply the captured colour to in the computer generated image of the user's body/face. If a particular product can be used in different regions of a body/face, such as a combined lip, cheek and eye colour, the user may wish to specify that the colour should be applied to the lips rather than the cheeks and eyes in the image, for example.

It may be that multiple colours are captured. For example, if an image is captured of a hair dye box, then the colours of the hair, skin and lips of the model on the hair dye box may be captured. In some examples the apparatus/device 500 may be able to match each captured colour with a corresponding facial feature (for example by using facial recognition technology applied to the image of the model on the hair dye box). Then the user may select which feature in the computer generated image of his/her face to apply a captured colour to, and the apparatus/device 500 may use the colour captured for that particular feature from the hair dye box and apply the colour to the corresponding feature in the computer generated image of the user's face. In some examples the apparatus/device 500 may not be able to match the captured colours with particular facial features, but may simply record each captured colour. The user may select a particular captured colour, as well as selecting which facial feature in the computer generated image of his/her face to apply the selected captured colour to. The apparatus/device 500 can then apply the selected captured colour to the selected particular feature on the computer generated image of the user's face.

FIGS. 6a-6b illustrate user-selectable products. FIG. 6a shows a list of products displayed for user selection on an apparatus/device 600 and FIG. 6b shows a graphical representation of products displayed for user selection on an apparatus/device 600. Example option buttons 650, 652 and a scroll arrow 654 are indicated but other options may be provided. Of course in other examples both text and graphics may be presented for user-selection.

In FIG. 6a, the example products listed are lipstick 602, eyeshadow 604, eyeliner 606, mascara 608, concealer 610, blusher 612. In FIG. 6b, the example facial features are displayed as graphical representations of lipstick 614, eyeshadow 616, eyeliner 618, mascara 620, concealer 622, blusher 624.

Of course other products than those shown in FIGS. 6a and 6b may be provided for selection, such as a wig product, a hair colour/hair dye product, an eye area colour product such as eyeshadow, eyeliner or coloured contact lenses, an eyelash colour product such as mascara, an eyebrow colour product, and/or a foundation product. In some examples the list/graphical menu may be provided as a menu-submenu system as discussed in relation to FIGS. 5a and 5b.

It may be that a colour has been captured but the apparatus/device 500 requires user input to know what product the captured colour applies to. The user can select a product from a list as in FIG. 6a or a graphical menu as in FIG. 6b to provide an input to the apparatus/device 600 instructing the product type which the colour has been captured from. From the indicated product type, the apparatus can apply the captured colour to a corresponding region of the computer generated image of the user's face. For example, if the user selects “blusher” the apparatus can provide for the blusher colour to be applied to the cheek regions in the image since blusher is logically for application to the cheeks. If the user selects “wig product” then the apparatus can provide for the colour of the wig to be applied to the user's hair in the image.

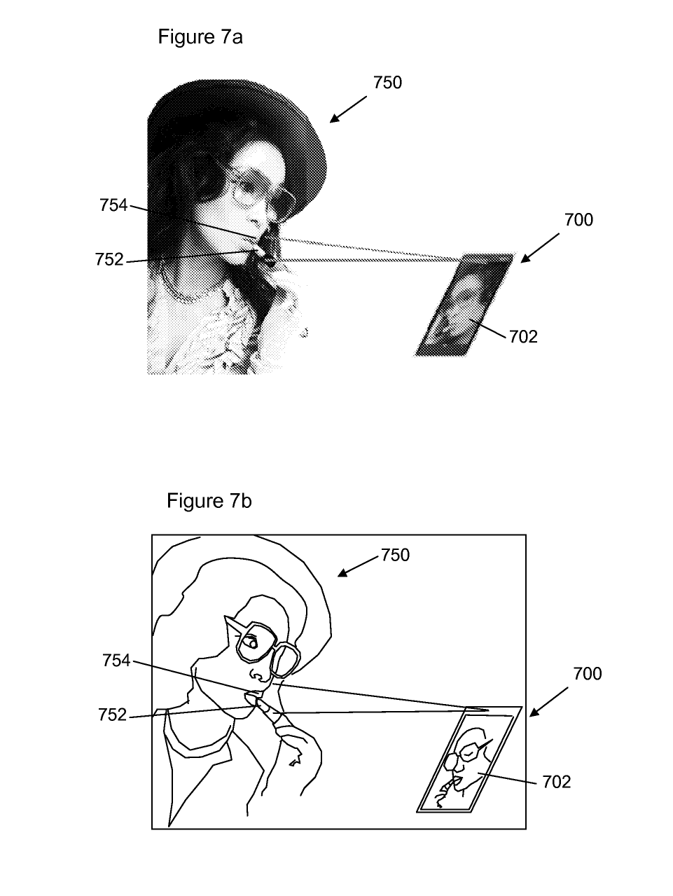

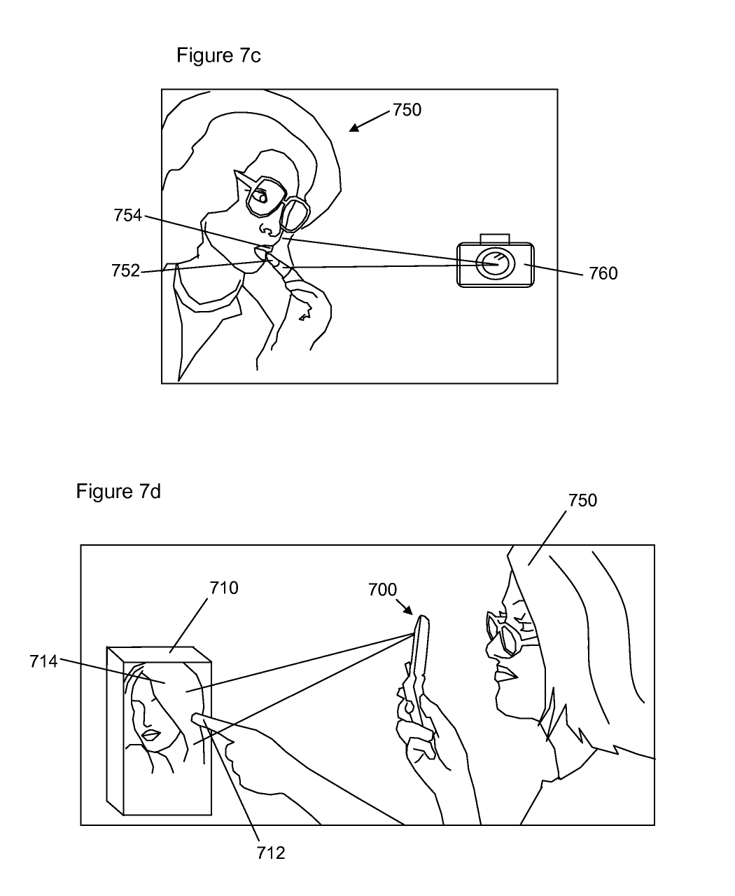

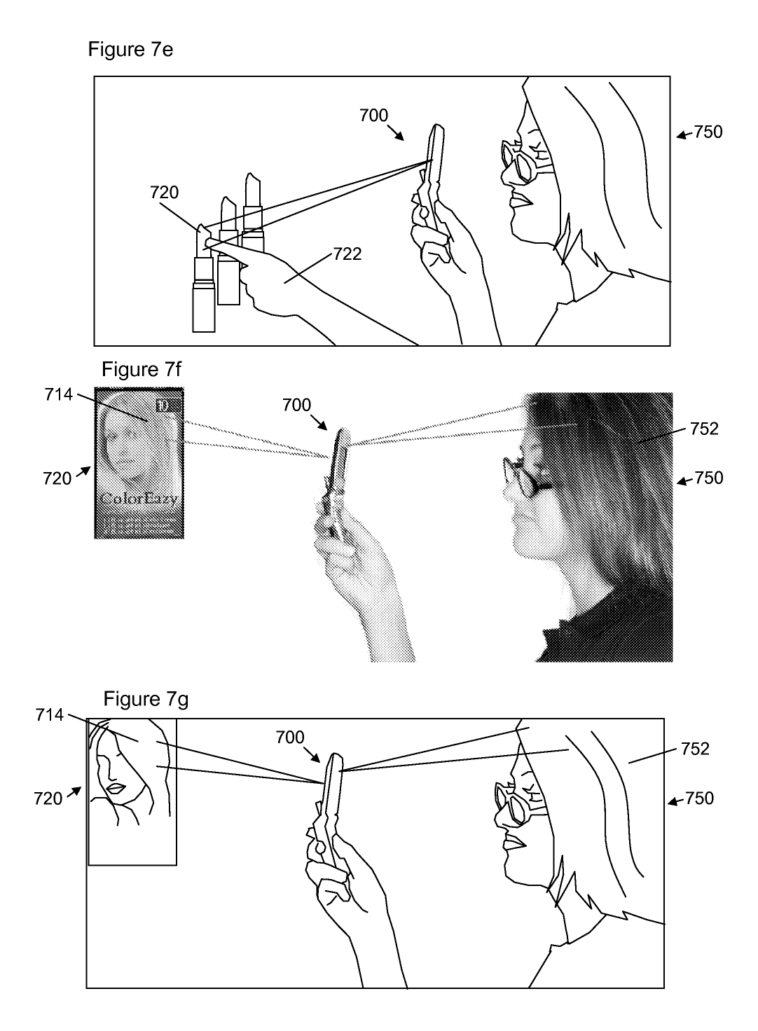

FIGS. 7a-7g illustrate capturing a colour from the real world, identifying a user indicated product type form the real world, and identifying a facial feature from a user indication.

FIGS. 7a and 7b show a person 750 holding a lipstick 752 to her lips 754. The user has an apparatus/device 700 with a front facing camera (not shown). The camera can record an image of the user's face, as indicated on the display screen 702 of the apparatus/device 700. Within the field of view of the camera in this example are the user's lips 754 and the lipstick 752.

In this example, the apparatus/device 700 is configured to identify the facial feature of the user's lips 754 for the application of a captured lipstick colour based on user indication of the user's lips 754 in the real-world. The user 750 makes the user indication to the apparatus/device 700 by pointing to her lips 754 with the lipstick 752. The apparatus/device 700 is able to detect where on her face the user is pointing by using facial recognition technology and identifying that a pointer (the lipstick 752) is pointing to the region of the user's face identified as being the lip region 754. The user indication of the lips facial feature 754 is made on the same face to which the captured colour is applied, since the user is pointing to her own lips 754 and the computer generated image 702 to be modified with the captured lipstick colour is an image of the same user 750.

Also in this example, the apparatus/device 700 is configured to use the camera comprised with the apparatus/device 700 to capture the image of the user's face for the generation of the computer generated image 702 of the user's face to which the captured colour is applied. In some examples the computer generated image 702 may be a pre-loaded or pre-stored image of the user's face, captured using the camera of the apparatus/device 700 or using another camera and provided to the apparatus/device 700.

Also in this example, the apparatus/device 700 is configured to use the camera comprised with the apparatus/device 700 to capture the colour from the real-world object, namely the lipstick 752. The apparatus/device 700 is able to determine the user's facial features using facial recognition technology, and is able to identify a pointer 752 indicating a feature 754 on the user's face. It can also determine the colour of the item used for pointing 752. The apparatus/device 700 may be able to determine that the item used for pointing 752 is a particular cosmetic item from the determined shape of the pointing item. For example, the shape of the lipstick 752 may be compared with predetermined shapes of cosmetic products to determine the “pointer” is a lipstick.

Thus in this example the apparatus/device 700 uses the image 702 captured using the front facing camera to determine the lips facial feature in the computer generated image 702 and to determine the colour to be applied to the lips in the image 702 to which colour is applied based on the colour captured from the lipstick 752 used for pointing to the user's lips 754.

In FIG. 7c, similarly to FIGS. 7a and 7b, a camera 760 is used to record the image of the user pointing to her lips 754 with the lipstick 752. The camera 760 is a separate device to the apparatus/device 700 which provides for application of the captured lipstick colour to the lip feature in the computer generated image of the user's face 702. The apparatus/device 700 in this example receives an indication of the colour to capture and the facial feature to which it relates from the image captured by the camera 760 based on detection of what the user is pointing to in the captured image and detection of the colour of the pointing object (the lipstick 752).

FIG. 7d shows a person 750 holding an apparatus/device 700 with an integral rear/outward facing camera (not shown) so that the field of view of the camera is directed to a cosmetic product packaging, in this example a hair colour packet 710. The hair colour packet 710 shows an image of a model with the hair colour applied to her hair 714, so the colour of the hair product is shown. The camera can record an image of the hair colour packet 710.

The user 750 is pointing 712 to the hair 714 on the hair colour packet 710 to indicate the colour which the user is interested in and also to indicate the facial feature type to which the colour should be applied in the image. The camera may record an image of the packet 710 including more than one colour, such as an image including the model's hair, face, eyes and lips. The apparatus/device 700 is configured to identify the facial feature of the model's hair 714 based on the user 750 pointing 712 to the hair 714 on the real-world hair colour packet 710. The apparatus/device 700 is configured to also identify the colour to capture based on the user pointing 712 to the colour of the model's hair 714 on the real-world hair colour packet 710. Thus, when the camera records an image of the packet 710, the colour of the hair 712 is captured and the facial feature of interest is captured for application to an image of the user's face, because the user has indicated the hair 712 feature and the hair colour by pointing to the hair area on the hair colour packet 710. In this example the user indication of the facial feature in the real world is of a different face to the user's own.

In another example, it may be that the user 750 points to a feature on a friend's face and captures an image. The user may, for example, point to a friend's cheek because she likes the shade of blusher her friend has used. The user may capture an image of her friend with the user's finger indicating the cheek area. The apparatus/device 700 is configured to identify the facial feature of the friend's cheek for the application of the captured blusher colour to a computer generated image of the user's face based on the user pointing to the cheek on her friend's face. The apparatus/device receives an indication of the colour to capture and the facial feature to which it relates based on detection of what area/colour the user is pointing to. Thus a computer generated image of the user's face may be edited by the automatic application of the detected blusher colour to the recognised cheek area in the image of the user.

In other examples, a user may point to a facial feature on an advertising poster or in a magazine. In this way a user can see if he/she likes the colour of the product applied to his/her own face in a computer generated image before, for example, ordering the product or finding a store stocking that particular product.

FIG. 7e, similarly to FIG. 7d, shows a person 750 holding an apparatus/device 700 with an integral rear/outward facing camera (not shown) so that the field of view of the camera is directed to a cosmetic product, in this example a lipstick 720. The shape and the colour of the lipstick 720 can be recorded by the camera in an image.

The user 750 is pointing 722 to the lipstick of interest 720 from a range of available lipsticks of different colours, to indicate the colour which the user is interested in. The facial feature to which the colour should be applied in an image is determined from the captured shape of the lipstick product 720. The apparatus/device 700 may be able to determine the shape of the product which the user is pointing to, and from that shape, determine what the product type is. The determination may be, for example, through a comparison of the captured product shape and a database of product/cosmetic shapes to match the captured product shape to a particular product. From this product type, the apparatus/device 700 may determine a corresponding facial feature to which the colour of the product can be applied in an image of a face since lipstick is logically applied to the lips. Thus, when the camera records an image, the colour of the lipstick 720 is captured and the facial feature of interest is determined to be lips from identification of the shape of the indicated lipstick product and association of that shape with a particular facial feature (i.e. lipstick is applied to the lips).

The camera may record an image including more than one colour, such as an image including the lipstick of interest and nearby other lipsticks or other products. The apparatus/device 700 is configured to identify the colour and product of interest 720 based on user pointing 722 to the lipstick 720 which she is interested in.

If an ambiguity arises, for example, the shape of the product is determined to match more than one product type, or the product type is determined to be suitable for application to more than one facial feature, the apparatus/device 700 may, for example, present a list of matching candidates so the user can select the correct one. An example of different product types having similar shapes may be a compact case which may contain foundation powder (applicable to the whole face), a blusher (applicable to the cheeks) or an eyeshadow (applicable to the eyelids and/or browbones). An example of a product suitable for application to more than one type of facial feature may be a shimmer powder which may be applied to the browbones, cheeks, or lips.

FIGS. 7f and 7g show a person 750 holding an apparatus/device 700 with an integral rear-facing camera (not shown) so that the field of view of the rear-facing camera is directed to a cosmetic product, and an integral front-facing camera directed to the user's face when the apparatus/device 700 is held in front of the user's face. The rear-facing camera is directed to the coloured hair part of the image 714 on a hair dye product 710. The front-facing camera is directed towards the user's hair 752 and can record an image of the user's face.

In this example, the apparatus/device 700 is configured to identify the facial feature of the user's hair 752 for the application of a captured hair colour based on computer based auto recognition of the user's hair 754 in the real-world. For example this may be done using facial recognition technology and comparison of the image captured by the front-facing camera with previous captured images of the user's face. The user may have pre-stored an image of her face and facial recognition technology may have been applied to determine the different facial features in the image. Properties of the different identified facial features may be determined, such as the texture and colour of each feature, for example. The apparatus may be able to compare the current image recorded by the front-facing camera, currently directed on the user's hair, to the identified facial regions in the pre-stored facial image, thereby determining that the front-facing camera is currently pointing to the user's hair.

Automatic detection of a hair region in a computer generated image may be performing using colour information. For example, a region of similar colour above an identified face region may be considered as hair. Differences in lighting over a feature may be accounted for using image processing techniques such as normalising pixel intensity values.

The apparatus/device 700 in this example can apply a captured colour to the hair region in a computer generated image of the user, since the feature currently in the field of view of the front-facing camera has been matched to the user's hair from a pre-stored and pre-analysed facial image.

The rear-facing camera is directed towards the coloured hair region of the image 714 on a hair dye product 710. This colour may be captured by the rear-facing camera and the apparatus/device 700 may provide for the application of this captured colour to the identified hair region in an image of the user's face.

In this example, the user does not need to make an indication of facial feature or product other than by directing the cameras to the feature of interest on her face and on the real-world product. The apparatus may provide different viewfinders to aid the user in directing the cameras, such as a split-screen view or viewfinder view on a display of the apparatus/device 700.

In some examples, the apparatus may be configured to provide for the application of captured colour, comprising a single captured colour, from the real-world object, to the identified facial feature. For example, a camera may capture substantially a single colour from, for example, an eyeshadow pot or foundation tube.

In some examples, the apparatus may be configured to provide for the application of captured colour, comprising a plurality of captured colours, from the real-world object, to the identified facial feature. For example, the captured colours may be a range of shades of a hair colour applied to hair. The range of shades may arise from the hair being shiny, so the shine provides lighter coloured areas and shadow provides darker colour areas in the image. The apparatus may be configured to provide for the application of algorithms to account for the changes in lighting over the captured colour feature and apply these correspondingly to a facial feature in a computer generated image, Thus, lighter captured hair colours may be mapped onto correspondingly lighter hair regions within the computer generated hair facial feature, and darker captured hair colours may be mapped onto correspondingly darker hair regions.

In some examples, the apparatus may be configured to provide for the application of one or more of the captured colours from a plurality of captured colours, from the real-world object, to the identified facial feature based on user selection of the one or more captured colours. For example, a captured image of a photograph may capture a skin colour, a lipstick colour and an eyeshadow colour. In some examples the user may be able to select a particular colour and/or feature from the captured coloured features to apply that colour to a corresponding feature in an image of his/her body/face. In some examples the user indication of a particular part of the image comprising the different colour may serve to indicate the colour (and/or feature) of interest for applying that colours to an image of the user's body/face.

The underlying texture and/or lighting variations of a body/facial feature may be retained after application of a captured colour by using colour enhancement (rather than applying a block of the captured colour to the identified body/facial feature). For example, if a lip region should be made a certain shade of red, then the colour components of the captured red colour may be added to the corresponding components of the existing pixel in the computer generated image. In this way the texture/colour variation of the feature may be retained.

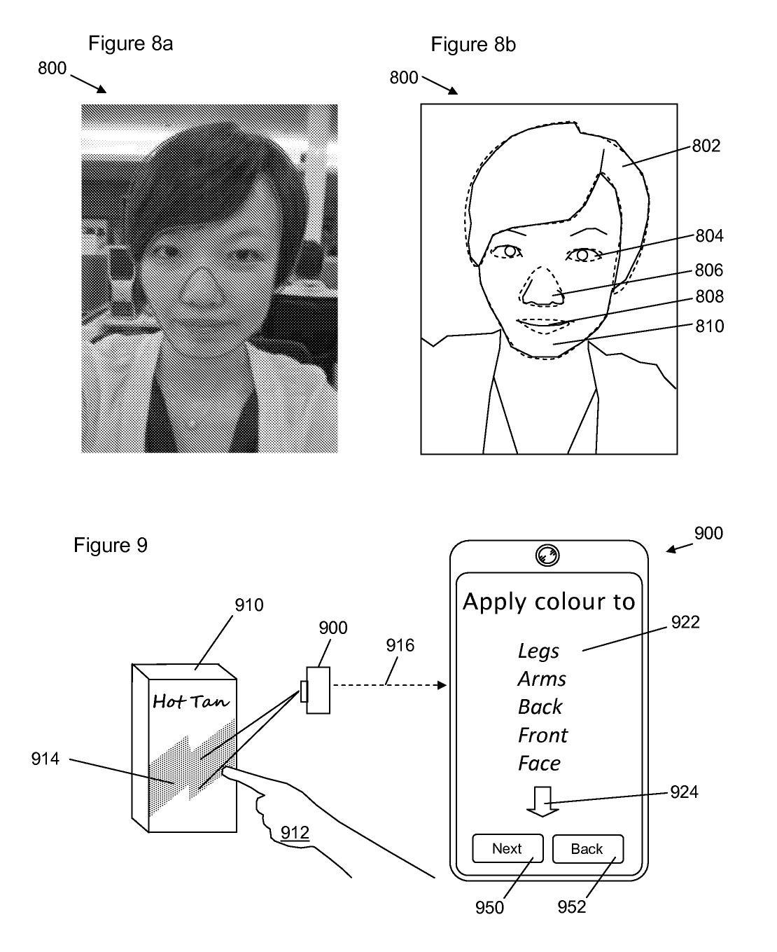

FIGS. 8a and 8b indicate how facial recognition may be used to identify different facial features from an image of a face 800. The image 800 may be a pre-stored facial image, a live facial image, or a movie (pre-stored or real-time) of a face. In this example, the hair 802, eyes 804, nose 806, mouth/lips 808 and face 810 are identified and indicated. In some examples more or less detail may be determined. For example, if interested in hair colour only, the hair region only may be identified, thereby not expending computing power on identifying features which are not of interest. In some examples, more detailed regions may be determined. For example, if interested in eye make-up, the eye region may be split in separate identified regions corresponding to the eyebrow, browbone, eyelid, upper and lower lash lines, and upper and lower eyelashes, for example. This may allow for the virtual testing of a complete make-up look or a range of complementary products.

FIG. 9 shows a person indicating 912 the colour 914 of a cosmetic product 910 (tanning product) for use on the body (not necessarily the face, although it may be applied to the face). The person captures a photograph of the product colour 914 and user indication 912 using a camera 900. The field of view of the camera 900 is directed to the tanning product packaging and the colour 914 of the tanning product 910, as well as capturing the user indicating 912 the colour.

The camera 900 transmits 916 the captured image to an apparatus/device 920 (for example, by a wireless connection such as Bluetooth, or over a wired connection). The apparatus/device 920 is configured to identify the captured colour 914 based on the user pointing 912 to the colour 914 of the tanning product on the box 910.

In this example, the apparatus 920 does not automatically determine what body feature this colour could be applied to, so the user is presented with a menu 922 from which to select which body feature(s) to apply the captured colour to in a computer generated image of the user's body. The menu 922 in this example is a text menu. Other options may be displayed by scrolling 924. Other menu options such as “next” 950 (for example, to preview the computer generated image including the captured colour applied to the selected body feature) or “back” 952 (for example, to re-capture the colour or capture a different colour) are available in this example.

In other examples, the tanning product packaging 910 may show the product colour 914 in the shape of a ladies leg. The apparatus/device may be able to determine that the body feature to which to apply the captured colour in a computer generated image of a body is the leg area, based on identification of the shape of a ladies leg indicated by the user when indicating the colour of interest. The leg region in a computer generated image may be identified by the apparatus using shape recognition of body parts, a human body part detection algorithm, or by manual tracing of body features in the computer generated image, for example.

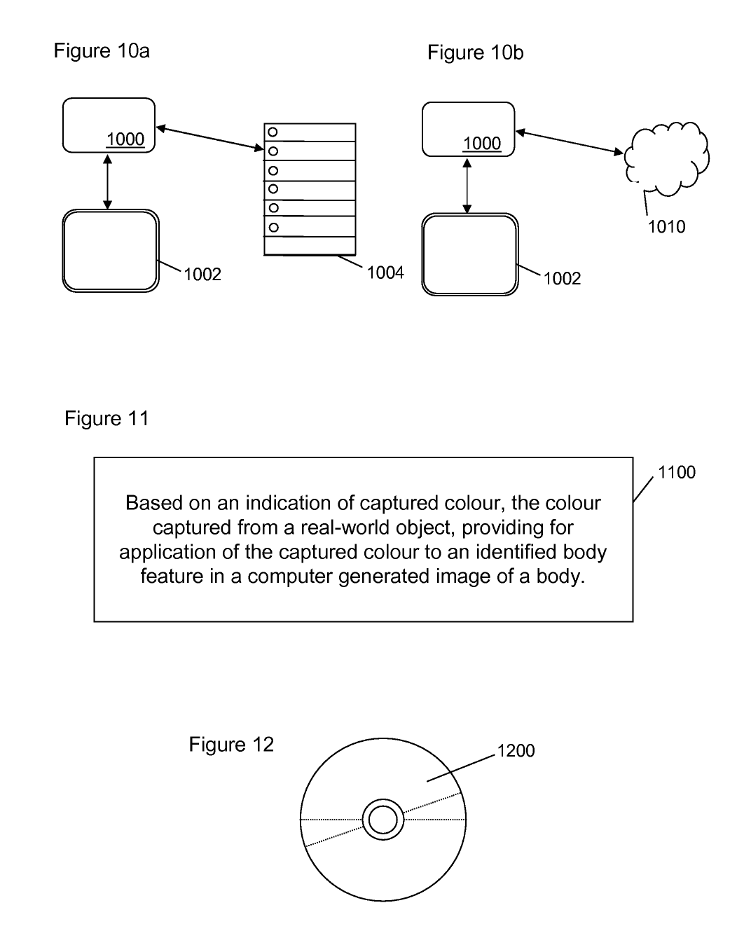

FIG. 10a shows an example of an apparatus 1000 in communication with a remote server. FIG. 10b shows an example of an apparatus 1000 in communication with a “cloud” for cloud computing. In FIGS. 10a and 10b, apparatus 1000 (which may be apparatus 100, 200 or 300 for example) is also in communication with a further apparatus 1002. The further apparatus 1002 may be a front facing or rear-facing camera, for example. In other examples, the apparatus 1000 and further apparatus 1002 may both be comprised within a device such as a portable communications device or PDA. Communication may be via a communications unit, for example.

FIG. 10a shows the remote computing element to be a remote server 1004, with which the apparatus 1000 may be in wired or wireless communication (e.g. via the internet, Bluetooth, NFC, a USB connection, or any other suitable connection as known to one skilled in the art). In FIG. 10b, the apparatus 1000 is in communication with a remote cloud 1010 (which may, for example, be the Internet, or a system of remote computers configured for cloud computing). For example, the apparatus providing/capturing/storing computer generated images of faces and/or edited versions of the images may be a remote server 1004 or cloud 1010. Facial recognition may run remotely on a server 1004 or cloud 1010 and the results of the facial recognition may be provided to the apparatus 1000. In other examples the further apparatus 1002 may also be in direct communication with the remote server 1004 or cloud 1010.

FIG. 11 illustrates a method 1100 according to an example embodiment of the present disclosure. The method comprises, based on an indication of captured colour, the colour captured from a real-world object, providing for application of the captured colour to an identified facial feature in a computer generated image of a face.

FIG. 12 illustrates schematically a computer/processor readable medium 1200 providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
based on an indication of captured colour, the colour captured from a real-world object, provide for application of the captured colour to an identified body feature in a computer generated image of a body.

2. The apparatus of claim 1, wherein the identified body feature is a facial feature.

3. The apparatus of claim 1, wherein the apparatus is configured to identify the body feature for the application of the captured colour based on user indication of one or more of:
the body feature from a display of selectable body features;
the body feature in the real-world; and
the body feature from a display of one or more selectable products respectively associated with a particular body feature.

4. The apparatus of claim 3, wherein the display of selectable body features is one or more of: a list of selectable body features; and a graphical representation of selectable body features.

5. The apparatus of claim 3, wherein the user indication of the body feature in the real-world is provided to the apparatus by a camera of the apparatus or a camera external to the apparatus.

6. The apparatus of claim 3, wherein the user indication of the body feature in the real-world is at least one of: a body feature of the same body to which the captured colour is applied; and a body feature of a different body to which the captured colour is applied.

7. The apparatus of claim 3, wherein the display of one or more selectable products comprises one or more of a list or graphical representation of: a wig product, a hair colour product, a lipstick product, an eye area colour product, an eyelash colour product, an eyebrow colour product, a concealer product, a foundation product, a blusher product, a tanning product and a nail colour.

8. The apparatus of claim 3, wherein the selectable product is associated with the real-world object from which the colour has been captured.

9. The apparatus of claim 2, wherein the apparatus is configured to identify the facial feature for the application of the captured colour based on computer-based auto-recognition of one or more of:
the facial feature in the computer generated image of the face;
the facial feature in the real-world; and
the facial feature from a real-world product associated with a particular facial feature.

10. The apparatus of claim 2, wherein the apparatus is configured to perform facial recognition to identify the facial feature to which the captured colour is applied.

11. The apparatus of claim 1, wherein the apparatus comprises a camera, and wherein the apparatus is configured to use the camera to capture one or more of:
the colour from the real-world object; and
an image of a body for generation of the computer generated image of the body to which the captured colour is applied.

12. The apparatus of claim 1, wherein the apparatus is configured to provide for the application of captured colour, comprising a single captured colour, from the real-world object, to the identified body feature.

13. The apparatus of claim 1, wherein the apparatus is configured to provide for the application of captured colour, comprising a plurality of captured colours, from the real-world object, to the identified body feature.

14. The apparatus of claim 1, wherein the apparatus is configured to provide for the application of one or more of the captured colours from a plurality of captured colours, from the real-world object, to the identified body feature based on user selection of the one or more captured colours.

15. The apparatus of claim 1, wherein the identified body feature is: hair, lips, skin, cheeks, under-eye area, eyelids, eyelashes, lash-line, brow bones, eyebrows, an arm, a leg, a hand, a foot, a fingernail, a toenail, a chest, a torso, or a back.

16. The apparatus of claim 1, wherein the real-world object is: a cosmetic product, a package for a cosmetic product, a colour chart, an image of a body, an image of a face, a real-world body or a real-world face.

17. (canceled)

18. The apparatus of claim 1, wherein the apparatus is configured to apply the captured colour to the identified body feature in the computer generated image of the body.

19. The apparatus of claim 1, wherein the apparatus is one or more of: a portable electronic device, a mobile phone, a smartphone, a tablet computer, a surface computer, a laptop computer, a personal digital assistant, a graphics tablet, a pen-based computer, a digital camera, a watch, a non-portable electronic device, a desktop computer, a monitor/display, a household appliance, a server, or a module for one or more of the same.

20. A method, the method comprising:
based on an indication of captured colour, the colour captured from a real-world object, providing for application of the captured colour to an identified body feature in a computer generated image of a body.

21. A computer readable medium comprising computer program code stored thereon, the computer readable medium and computer program code being configured to, when run on at least one processor perform at least the following:
based on an indication of captured colour, the colour captured from a real-world object, provide for application of the captured colour to an identified body feature in a computer generated image of a body.
